(19) United States
(12) Patent Application Publication
(10) Pub. No.: US 2013/0286264 A1
(43) Pub. Date: Oct. 31, 2013

(54) IMAGING DEVICE AND PROJECTOR UNIT

(71) Applicant: SONY CORPORATION, Tokyo (JP)

(72) Inventors: Masaaki KAMIKURA, Tokyo (JP); Yoshihisa Tsuchida, Kanagawa (JP); Hisato Sawanami, Aichi (JP)

(73) Assignee: SONY CORPORATION, Tokyo (JP)

(21) Appl. No.: 13/794,942

(22) Filed: Mar. 12, 2013

(30) Foreign Application Priority Data
Apr. 27, 2012 (JP) 2012-102237

(51) Int. Cl. H04N 5/232

(52) U.S. Cl. CPC H04N 5/23293
USPC 348/294; 348/789

(57) ABSTRACT

There is provided an imaging device including an image generator, a translucent mirror configured to reflect at least a portion of light emitted from the image generator and to emit the reflected light toward an outside of a housing, and an image sensor configured to receive light transmitted through the translucent mirror among light incident from the outside of the housing.

### BACKGROUND

The present disclosure relates to an imaging device and a projector unit. In particular, the present disclosure relates to an imaging device capable of projecting a recorded image.

In recent years, digital cameras have become widely used. Since the digital camera can display image data on a display unit or the like, it has the advantage of allowing the user to view immediately the image obtained by photographing.

In this regard, there is a need for sharing the image obtained by photographing with other many people. For example, there are cases where many people want to view one image together, such as when a user takes a commemorative photograph with his/her friends or family members.

As an example of how to view the image obtained by photographing together with friends or family members, a method of projecting the image using a projector may be employed. For example, Japanese Patent Application Laid-Open Publication No. 2004-252118 discloses a projector device having a digital camera that is built in the liquid crystal projector, and the projector device employs a common lens used for projection of the liquid crystal projector and for photographing of the digital camera.

### SUMMARY

It is desired to provide a simple method for sharing the image obtained by photographing or the like.

According to a first preferred embodiment of the present disclosure, there is provided an imaging which includes an image generator, a translucent mirror, and an image sensor. The translucent mirror may reflect at least a portion of light emitted from the image generator and emit the reflected light toward an outside of a housing. The image sensor may receive light transmitted through the translucent mirror among light incident from the outside of the housing.

According to a second preferred embodiment of the present disclosure, there is provided an imaging device which includes a connecting portion, a translucent mirror, and an image sensor. The connecting portion may be configured to be connectable to and detachable from the connecting portion. The translucent mirror may reflect at least a portion of light emitted from the image generation device and emit the reflected light toward an outside of a housing. The image sensor may receive light transmitted through the translucent mirror among light incident from the outside of the housing.

According to a third preferred embodiment of the present disclosure, there is provided an imaging device which includes a main body and a lens unit. The main body may include an image sensor. The lens unit may include one or more lenses and may be connectable to and detachable from the main body. An image generation device including a translucent mirror may be connectable and detachable between the main body and the lens unit. In a state where the image generation device is interposed between the main body and the lens unit, the lens unit, the translucent mirror, and the image sensor may be arranged substantially in a row.

According to a fourth preferred embodiment of the present disclosure, there is provided a projector unit which includes a housing, a translucent mirror, and an image generator. The housing may include a first connecting portion and a second connecting portion. The translucent mirror may be disposed between the first connecting portion and the second connecting portion. Light reflected by the translucent mirror among light emitted from the image generator may be emitted toward an outside through one of the first connecting portion and the second connecting portion.

As used herein, the term “optical path” is used as a path along which light travels, but it does not refer to the product of the distance that light travels and the index of refraction. In addition, as used herein, the term “optical path length” refers to the product of the distance that light travels and the index of refraction.

In accordance with an embodiment of the present disclosure, it is possible to provide a simple method for sharing the image obtained by photographing.

### BRIEF DESCRIPTION OF THE DRAWINGS

FIG. 1 is a diagram schematically illustrating an exemplary configuration of an imaging device according to a first embodiment of the present disclosure;

FIG. 2 is a functional block diagram illustrating an exemplary configuration of the imaging device according to the first embodiment of the present disclosure;

FIG. 3 is a diagram schematically illustrating an exemplary configuration of an optical system of the imaging device according to the first embodiment of the present disclosure;

FIG. 4A is a schematic diagram illustrating an exemplary cross section of a translucent mirror; FIG. 4B and FIG. 4C are schematic diagrams illustrating the influence of the warping of the translucent mirror on the travelling direction of light reflected by the translucent mirror;

FIG. 5 is a flowchart illustrating an exemplary process of mode switching performed in an imaging device according to an embodiment of the present disclosure;

FIG. 6A is a diagram schematically illustrating an exemplary configuration of an imaging device according to a second embodiment of the present disclosure;

FIG. 6B is a schematic diagram illustrating the imaging device shown in FIG. 6A, the imaging device having a projector unit connected thereto;

FIG. 7A is a diagram schematically illustrating an exemplary configuration of the projector unit shown in FIG. 6B; FIG. 7B is a diagram schematically illustrating another exemplary configuration of the projector unit;

FIG. 8 is a flowchart illustrating an exemplary process performed in the imaging device according to the second embodiment of the present disclosure;

FIG. 9 is an image view illustrating an exemplary screen for allowing a user to check whether the imaging device may be switched to a projector mode;

FIG. 10A is a diagram schematically illustrating an exemplary configuration of an imaging device according to a third embodiment of the present disclosure; FIG. 10B is a diagram schematically illustrating the imaging device having a projector unit mounted between the main body and the lens unit; and

FIG. 11A is an exploded perspective diagram of the imaging device which is divided into a lens unit, a projector unit, and a main body; FIG. 11B is a diagram schematically illustrating an exemplary configuration of the projector unit connected between the main body and the lens unit.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Embodiments of an imaging device and a projector unit will now be described. The description will be made in the following order.

1. First Embodiment
1-1. General Configuration of Imaging Device
   1-1-1. Main Body
   1-1-2. Lens Unit
1-2. Optical System in Imaging Device
   1-2-1. Translucent Mirror
1-3. Exemplary Process performed by Imaging Device
1-4. Effect

2. Second Embodiment
2-1. General Configuration of Imaging Device
   2-1-1. Connecting Portion
   2-1-2. Projector Unit
2-2. Exemplary Process performed by Imaging Device
2-3. Effect

3. Third Embodiment
3-1. General Configuration of Imaging Device
   3-1-1. Imaging Device
   3-1-2. Projector Unit
3-2. Imaging Device having Projector Unit connected thereto
   3-2-1. Standards of First and Second Connecting Portions
3-3. Exemplary Control performed by Imaging Device
3-4. Effect

4. Modifications

As will become apparent from the following description, in an embodiment of the present disclosure, one or more lenses disposed in a lens unit and a fixed translucent mirror are used for photographing, and the one or more lenses and the translucent mirror are also be used for projection. Thus, according to embodiments of the present disclosure, it is possible to realize a compact, lightweight imaging device that can perform both photographing and projection by using a single image forming optical system and also can be used as a projector.

Disclosed in the embodiments below is a preferred detailed embodiment of an imaging device and a projector unit. In the following description, although embodiments of the present disclosure will be described below with various technically preferred limitations, it should not be understood that examples of the imaging device and the projector unit are limited to embodiments described below unless expressly so defined herein.

### 1. First Embodiment

[1-1. General Configuration of Imaging Device]

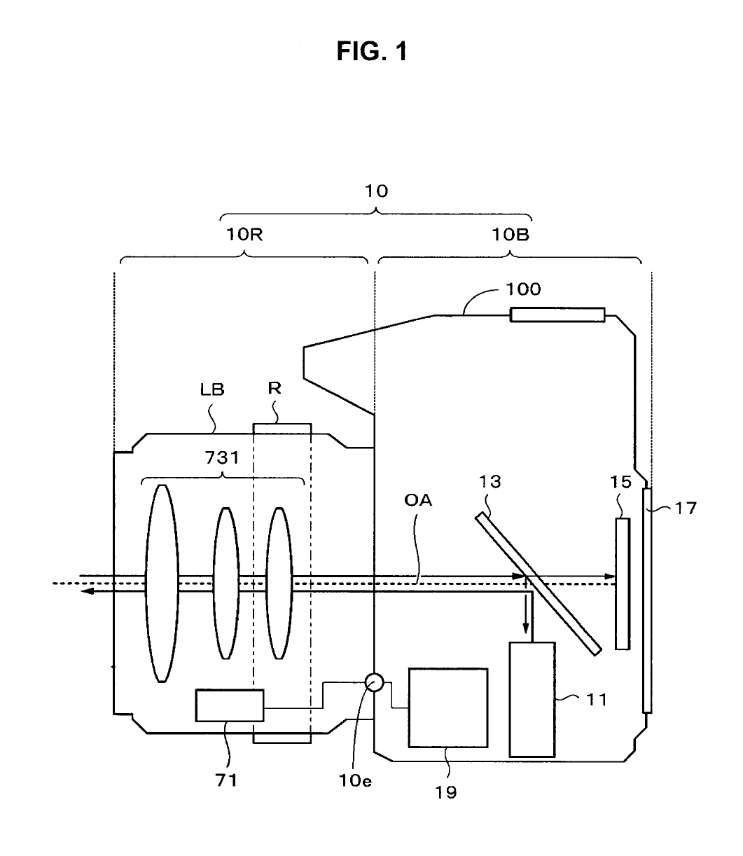

FIG. 1 is a diagram schematically illustrating an exemplary configuration of an imaging device according to a first embodiment of the present disclosure. FIG. 1 corresponds to a diagram illustrating the imaging device according to the first embodiment when viewed from the right side.

As shown in FIG. 1, an imaging device 10 includes an image generator 11, a translucent mirror 13, and an image sensor 15. Specifically, the imaging device according to the first embodiment is so called a digital camera with pellicle mirror.

As shown in FIG. 1, the imaging device 10 is configured to include, for example, a main body 10B and a lens unit 10R. In addition, a shutter mechanism or the like is not shown in FIG. 1. The same is also true of the following description.

(1-1-1. Main Body)

The main body 10B includes a housing 100 having disposed therein the image generator 11, the translucent mirror 13, and the image sensor 15.

The image generator 11 generates a projection image from the image data obtained by photographing or the like. The projection image is to be play backed on a screen or wall surface. The configuration of the image generator will be described in detail later.

The translucent mirror 13, when receiving an image signal related to a subject, allows at least a portion of the subject light to be reflected and the rest to be passed through it. In addition, the translucent mirror 13 reflects at least a portion of light emitted from the image generator 11 and emits the reflected light to the outside of the housing 100. The translucent mirror 13 is fixed inside the housing 100 so that it may be inclined with respect to an optical axis OA of the light (hereinafter, appropriately referred to as a “subject light”) incident from the outside of the imaging device through the lens unit to be described later. The configuration of the translucent mirror will be described in detail later.

The image sensor 15 converts light incident through the translucent mirror 13 into electrical signals. Specifically, the image sensor 15 receives the light transmitted through the translucent mirror among the subject light and outputs an image signal related to the subject.

(1-1-2. Lens Unit)

The lens unit 10R may be connectable to and detachable from the main body 10B. The detachable connection of the lens unit 10R to the main body 10B makes a possible for a user to select the most suitable lens unit among a plurality of types of lens units depending on photographing scenes. A description will be made below based on the assumption that the lens unit 10R is connectable to and detachable from the main body 10B. Alternatively, the lens unit 10R and the main body 10B may be integrally formed with each other.

The lens unit 10R includes one or more lenses 731 which allow an image related to the subject to be image-formed on an imaging plane of the image sensor 15. In addition, the lens unit 10R includes a lens drive mechanism 71 which adjusts the focus or an aperture drive mechanism which adjusts the aperture.

The autofocus of the imaging device is achieved by shifting the one or more lenses 731 by the lens drive mechanism 71 which is disposed inside a lens barrel LB of the lens unit 10R. An actuator for driving the lens drive mechanism 71 may be disposed in the main body 10B or the lens unit 10R. When the actuator is disposed only in the main body 10B, for example, the power for shifting the one or more lenses 731 is transferred from the main body 10B to the lens unit 10R by a mechanical drive force transfer mechanism. Alternatively, when the actuator is disposed in the lens unit 10R, a control signal or electric power for driving the lens drive mechanism 71 is supplied from a controller 19 of the main body 10B to the lens drive mechanism 71 through an electrical contact 10e which is provided between the lens unit 10R and the main body 10B.

Further, the lens barrel LB the of the lens unit 10R is provided with a ring R which is used to adjust the focus, as necessary. The user of the imaging device according to the embodiment of the present disclosure (hereinafter, simply appropriately referred to as a “user”) can shift the lens by rotating the ring and thereby performing the manual focus.

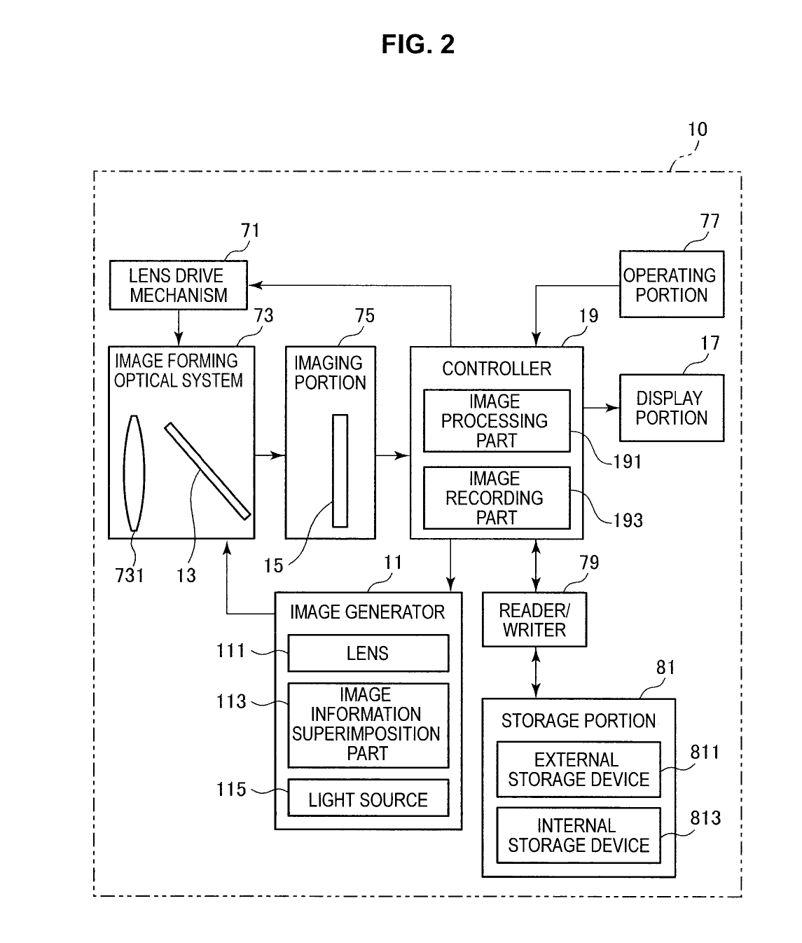

FIG. 2 is a functional block diagram illustrating an exemplary configuration of the imaging device according to the first embodiment of the present disclosure.

An image forming optical system 73 may include the one or more lenses 731 disposed in the lens unit 10R and the translucent mirror 13 disposed in the main body 10B. The image forming optical system 73 functions as an optical system which allows an image related to a subject to be formed on the imaging plane of the image sensor 15 at the time of the photographing of the subject. The image forming optical system 73 also functions as an optical system which allows an image related to a projection image to be image-formed on a screen or wall surface at the time of the projection of the projection image.

An imaging portion 75 includes the image sensor 15. The image sensor 15 may include a CMOS (complementary metal-oxide semiconductor), a CCD (charge-coupled device), and so on. The image sensor 15 outputs an image signal related to a subject by performing a photoelectric conversion. The image signal related to the subject obtained by the imaging portion is output to the controller 19 to be described later.

An operating portion 77 includes various types of buttons, such as a group of function buttons or release buttons disposed on the housing 100 of the main body 10B. The operating portion 77 functions as a user interface which operates the imaging device 10. The operating portion 77 may include an external control device such as a remote controller.

Moreover, the operating portion 77 preferably includes a directional pad. This is because, for example when lighting in a room is turned off, the user can perform an input operation by hand. An operation signal is produced in response to the user's input operation received by the operating portion 77. The operation signal is output to the controller 19 to be described later.

The controller 19 is a processing device which includes a processor, a memory, and so on. The controller 19 is configured to include a digital signal processor (DSP) or a central processing unit (CPU). The controller 19 controls each of the components of the imaging device 10 and outputs the result obtained, for example, by performing the process corresponding to the input from the operating portion 77.

Programs, which are used for various types of arithmetic operations or for controlling each of the components of the imaging device 10, are stored, for example, in a RAM (Random Access Memory) and ROM (Read-Only Memory) disposed in the controller 19, a storage portion 81 connected to the controller 19, and so on.

The controller 19 includes an image processing part 191 which performs a predetermined signal processing on the image signal related to the subject output from the imaging portion 75. The signal processing performed on the image signal related to the subject may include digital gain adjustment, gamma correction, color correction, contrast correction, and so on.

The controller 19 includes an image recording part 193. The image recording part 193 compresses the image signal processed by the image processing part 191 using a compression coding method, such as JPEG (Joint Photographic Experts Group) and generates the compressed data. The image data generated from the image recording part 193 is stored, for example, in the storage portion 81.

A reader/writer 79 is an auxiliary device that performs reading of data from and writing of data to the storage portion 81. The reader/writer 79 functions as an interface between the storage portion 81 and the controller.

The storage portion 81 may include an external storage device 811 and an internal storage device 813. The external storage device 811 is connectable to and detachable from the imaging device 10. The internal storage device 813 is fixed inside the main body 10B. A recording medium applicable to the external storage device 811 or the internal storage device 813 may include a hard disk, a flash memory, an optical disk, a magneto-optical disk, a MRAM (Magneto-resistive Random Access Memory), and so on. The image data obtained by photographing is stored in the storage portion 81 through the reader/writer 79. The storage of the image data in the external storage device 811 or the internal storage device 813 is, for example, predetermined depending on the user's selection.

The display portion 17 may be a display device, such as a liquid crystal display (LCD), an organic EL (electroluminescence) display, and so on. The display portion 17 displays the image related to the subject obtained by performing the photoelectric conversion in the image sensor 15, and the display portion 17 displays the results obtained by performing the process corresponding to the input from the user. The display portion 17 may be configured to include a touch panel which functions as a user interface for operating the imaging device 10.

The image generator 11 generates a projection image to be played back on a screen or wall surface. The projection image is generated based on image data recorded in the storage portion 81 or image data supplied from a network or an external device connected to the imaging device 10.

The image generator 11 is provided with one or more light sources 115 and is further provided with one or more lenses 111, as necessary, in order to generate a projection image. The light source 115, which is used in the image generator 11, may include a light emitting diode (LED), a metal halide lamp, a halogen lamp, a xenon lamp, and so on.

Furthermore, the image generator 11 includes an image information superimposition part 113 which is used to generate a projection image, as necessary. The image information superimposition part 113 includes an optical semiconductor having a group of microscopic mirrors disposed therein, which is referred to as one or more liquid crystal displays (LCDs) or “DLP” (registered trademark of Texas Instruments Incorporated) chip.

For example, the image information superimposition part 113 is interposed between the one or more light sources 115 and the one or more lenses 111, and thus the image information related to the projection image can be superimposed onto the light emitted from the one or more light sources 115. In other words, for example, the light emitted from the one or more light sources 115 is reflected by one or more liquid crystal displays or “DLP” (registered trademark) chip, and thus image information related to the projection image is superimposed onto the light emitted from the one or more light sources 115. Alternatively, for example, the image information related to the projection image is superimposed onto the light emitted from the one or more light sources 115 by passing the light emitted from the one or more light sources 115 through one or more liquid crystal displays.

The image generator 11 may be configured to include, for example, a group of fine light sources corresponding to the number of pixels and to generate the projection image by the group of fine light sources.

The image generator 11 generates and emits the light related to the projection image. At least a portion of the light is reflected by the translucent mirror 13 of the image forming optical system 73 and is emitted to the outside of the housing 100 through the one or more lenses 731 of the image forming optical system 73. The light emitted to the outside of the housing 100 is image-formed, for example, on a screen, and thus the user can view the projection image. That is, the imaging device of the embodiment of the present disclosure provides not only a photographing function but also a projection function.

[1-2. Optical System in Imaging Device]

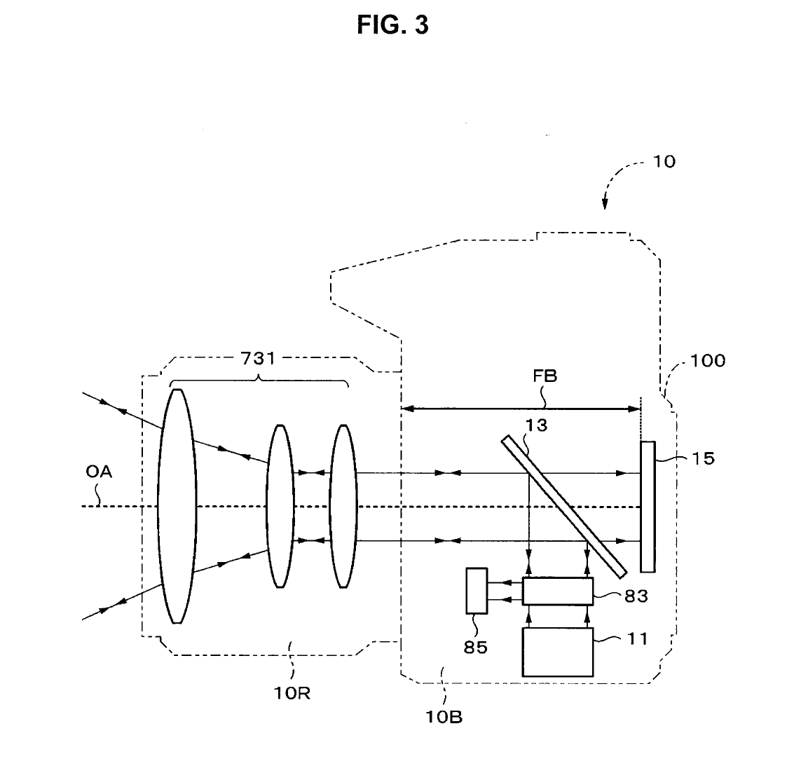

FIG. 3 is a diagram schematically illustrating an exemplary configuration of an optical system of the imaging device according to the first embodiment of the present disclosure. FIG. 3 corresponds to a diagram viewed from the right side of the imaging device according to the first embodiment.

In the first embodiment, the translucent mirror 13 is fixed inside the housing 100 of the main body 10B. In this case, the translucent mirror 13 is fixed inside the housing 100 of the main body 10B so that the translucent mirror 13 is inclined at an angle of, for example, about 45° with respect to an optical axis OA of the subject light.

As shown in FIG. 3, the image sensor 15 is disposed in the rear side of the translucent mirror 13 with respect to the one or more lenses 731 of the lens unit 10R. In other words, the one or more lenses 731, the translucent mirror 13, and the image sensor 15 are arranged substantially in a row along the optical axis OA. In this regard, the “arranged substantially in a row” means that the one or more lenses 731, the translucent mirror 13, and the image sensor 15 are arranged so that the light passing through the one or more lenses of the lens unit and the translucent mirror is incident on the image sensor. Therefore, the respective centers of the one or more lenses 731, the translucent mirror 13, and the image sensor 15 may be not necessarily arranged on the same straight line.

On the assumption that light is incident on the translucent mirror 13 through the one or more lenses 731, the image generator 11 is disposed in the direction in which light reflected by the translucent mirror 13 travels. Specifically, when the translucent mirror 13 is fixed inside the housing 100 of the main body 10B so that it is inclined at an angle of, for example, about 45° with respect to an optical axis OA of the subject light, if the image generator 11, the translucent mirror 13, and the image sensor 15 are connected in sequence, then they form nearly a right angle.

As shown in FIG. 3, when photographing a subject, the light incident from the outside of the housing 100 is incident on the image sensor 15 through the one or more lenses 731 and the translucent mirror 13, sequentially.

Further, the light reflected by the translucent mirror 13 among the subject light is guided to, for example, an auto-focus sensor 85 disposed below the translucent mirror 13 through an optical path switching unit 83 disposed inside the housing 100, as necessary. The optical path switching unit 83 may be, for example, an optical function element or a movable mirror capable of switching between transmission and reflection using an electro-chromic method.

In this regard, the user can use auto-focus function even when the image signal related to a subject is being obtained. Thus, the user can take photographs a moving subject while adjusting the focus. The auto-focus sensor 85 may be a sensor which employs a contrast detection method, but preferably, the auto-focus sensor 85 may be a sensor which employs a phase difference detection method faster than the contrast detection method.

On the other hand, at the time of projection of a projection image, the light emitted from the image generator 11 through the optical path switching unit 83 is incident on the translucent mirror 13. In addition, when the auto-focus sensor 85 and the image generator 11 are disposed inside the housing 100 so that the optical axis of light toward the auto-focus sensor 85 is not intersected with the optical axis of light emitted from the image generator 11 toward the translucent mirror 13, it may not be necessary to provide the optical path switching unit 83.

The light incident on the translucent mirror 13 is reflected by the translucent mirror 13 and then is emitted toward the outside of the imaging device 10 through the one or more lenses 731. The light emitted toward the outside of the imaging device 10 is image-formed, for example, on a screen.

In this way, according to the embodiment of the present disclosure, both of the incidence of light on the image sensor at the time of photographing and the emission of light related to the projection image at the time of projection are performed through one or more lenses of the lens unit.

When the imaging device 10 includes the lens unit 10R having one or more lenses 731 disposed therein, the autofocus or the manual focus by the user can be achieved by the lens drive mechanism 71 at the time of projection of the projection image. In addition, the user can select a lens unit suitable for projecting the projection image and then the user can mount the selected lens unit on the main body 10B.

The user can cause the imaging device 10 to adjust automatically the focus of the projection image which is projected on a screen. For example, when the image data related to a subject is recorded, the kinds of the lens unit 10R being used and the auto-focus distance may be recorded as additional information along with the image data. When the image data obtained by photographing is projected, for example, the user can cause the imaging device 10 to measure the distance to the screen in a similar manner to the auto-focus performed at the time of projection. Further, the user can cause the imaging device to calculate the amount of focus from the information related to the kinds of the lens unit 10R mounted on the main body 10B and the distance to the screen. The focusing of the projection image projected on the screen can be achieved by causing one or more lenses 731 of the lens unit 10R to be driven by the lens drive mechanism 71 based on the amount of focus obtained by the calculation.

In this way, according to the embodiment of the present disclosure, the projection image can be reliably projected on a screen or wall surface.

In accordance with the first embodiment as described above, the translucent mirror 13 is fixed inside the housing 100 of the main body 10B. For this reason, the individual arrangement of the image sensor 15, the image generator 11, and the translucent mirror 13 is adjusted according to the following procedure.

When assembling the imaging device, first, the image sensor 15 is disposed near the rear side of the imaging device in the housing 100 of the main body 10B. In this time, six-axis adjustment is performed for the image sensor 15 and the flange back FB thereof is adjusted. The six-axis adjustment is an adjustment to the shift amount for X, Y, and Z directions at the time of assumption of a XYZ rectangular coordinate system and the rotation amount about each axis.

Next, the image generator 11 is disposed below in the housing 100, and the position of the image generator 11 is adjusted in the longitudinal direction (direction along the optical axis OA).

Subsequently, the translucent mirror 13 is fixed inside the housing 100. After the optical path length from a portion to which the lens unit 10R is mounted to the translucent mirror 13 is fixed, the entire assembling of the main body 10B is completed.

(1-2-1. Translucent Mirror)

Exemplary configuration of the translucent minor according to an embodiment of the present disclosure will now be described. The translucent mirror may include a substrate layer and a translucent layer disposed on a main surface of the substrate layer.

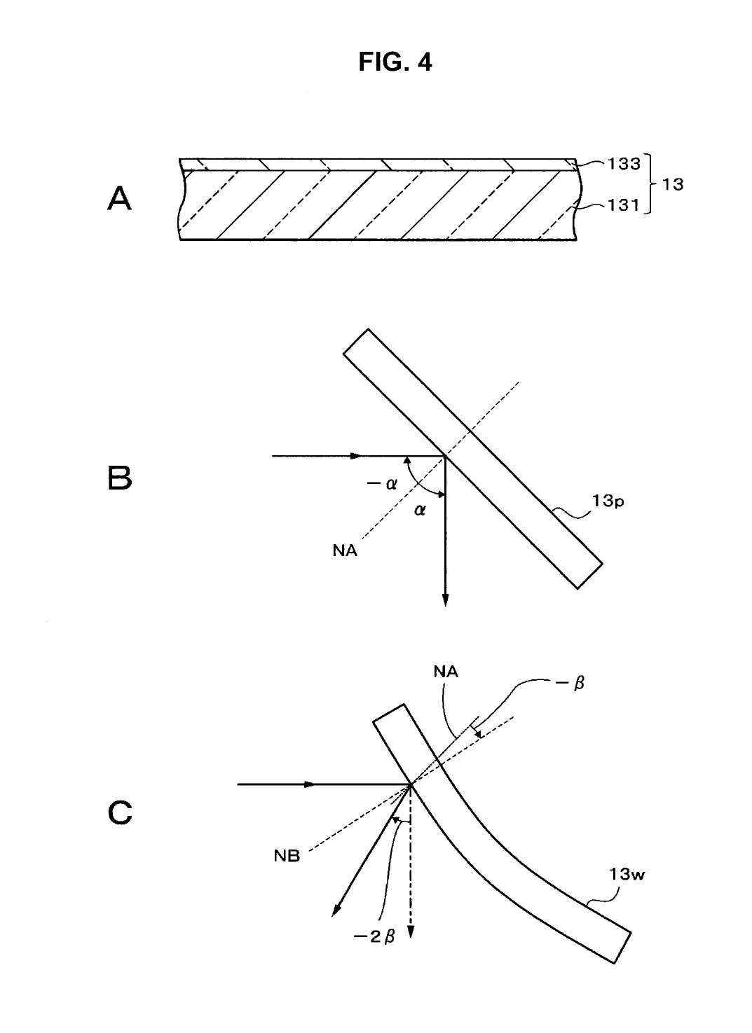

FIG. 4A is a schematic diagram illustrating an exemplary cross section of the translucent mirror.

The translucent mirror 13 is configured to include at least the substrate layer 131 and the translucent layer 133 which are stacked with each other. As shown in FIG. 4A, for example, the translucent layer 133 is formed on a main surface of the substrate layer 131.

The substrate layer 131 is a base substrate for supporting the translucent layer 133. The shape and size of the substrate layer 131 are not particularly limited, but the thickness of the substrate layer 131 is preferably as small as possible. Specifically, the substrate layer 131 preferably has thickness in the range from 10 micrometers (μm) to 100 micrometers (μm). The optical path length within the substrate layer 131 can be reduced in order to minimize the deterioration of image quality related to the image obtained by photographing. In addition, the short optical path length makes it possible to reduce the weight of the imaging device.

The substrate layer 131 is optically transparent. The substrate layer 131 is preferably highly transparent in the visible light region. This is because the sensitivity of the image sensor 15 is generally designed based on the visible light region. In this regard, the visible light region (also called a sensitivity region of the imaging device including a color filter) refers to a wavelength region of 400 nm to 700 nm. The substrate layer 131 preferably has light transmittance, for example, with a haze value of 0.9 or less. The translucent mirror 13 including the translucent layer 133 disposed on a main surface of the substrate layer 131 may exhibit a certain level of transmittance and reflectance. In addition, haze measurement conditions are conformed to JIS K 7361 (ISO 13468), JIS K 7136 (ISO 14782), JIS K 7105 or ASTM D 1003. The following haze measuring instrument is used. Measuring instrument: Haze Meter (NDH5000 manufactured by Nippon Denshoku Industries Co., Ltd.).

The substrate layer 131 is preferably optically isotropic with respect to the in-plane direction. Thus, the substrate layer 131 can further reduce the amount of light loss due to absorption at the time of incidence of light as compared to a case where the substrate layer 131 is optically anisotropic with respect to the in-plane direction. In addition, variation in the transmittance for each wavelength can be reduced and thus collapse of the white balance can be prevented. Moreover, the deviation at image formation positions in the vibration direction of light can be suppressed and thus the deterioration of image quality (resolution) related to the image obtained by photographing can be prevented.

In this regard, the “optically isotropic” refers to the condition in which ΔN=Nx−Ny (Nx>Ny, in this example) is less than 0.01, where Nx and Ny are refractive indexes in the two orthogonal directions in the in-plane. In the equation, ΔN is given using the relationship of (phase difference)=(thickness of sample)×ΔN obtained by directing a single wavelength light beam to the sample and measuring the phase difference of the transmitted light. In addition, the “optically isotropic” herein does not necessarily refer to the optically completely isotropic, but is intended to include a small level of anisotropy due to manufacturing errors or measurement errors (estimation errors). The following phase difference measuring instrument is used. Measurement Instrument: Phase Difference Meter (KOBRA manufactured by Oji Scientific Instruments).

Furthermore, the substrate layer 131 may be made of material with ΔN of 0.01 or more. In this case, the value obtained by measuring the phase difference is preferably 300 nm or less. When the phase difference is 300 nm or less, the effect on the deterioration of image quality for the image obtained by photographing becomes small.

The material of the substrate layer 131 may include polycarbonate (PC), cycloolefin polymer (COP), polyethyleneterephtalate (PET), polyethersulphone (PES), polyethylenenaphthalate (PEN), triacetylcellulose (TAC), polyimide, aramid (aromatic polyamide), and so on. The substrate layer 131 may be made of glass. In terms of the optical isotropy, the material of the substrate layer 131 is preferably made of polycarbonate that is an amorphous plastic, polyimide, and cycloolefin polymer. Alternatively, the material of the substrate layer 131 is preferably made of glass.

The substrate layer 131 may be made of material that is transparent in the visible light region and has the desired optical transparency. Thus, a film with an acrylic resin may be used for the substrate layer 131.

The translucent layer 133 is formed on one of main surfaces of the substrate layer 131. The translucent layer 133 is preferably formed on the surface of two main surfaces of the substrate layer 131 on which the subject light is incident.

The translucent layer 133 is designed so that the translucent mirror 13 has a certain level of reflectance and transmittance. For example, the translucent layer 133 is designed so that the translucent mirror 13 has reflectance of 30±10% (transmittance of 70±10%) in the visible light region.

The translucent layer 133 is a laminate, for example, made of high refractive index material and low refractive index material. The translucent layer 133 can be manufactured by alternately stacking a layer made of high refractive index material (hereinafter, referred to as a high refractive index layer) and a layer made of low refractive index material (hereinafter, referred to as a low refractive index layer). The high refractive index layer is made of material with a refractive index of 2.0 or more (e.g., between 2.0 and 2.5). The low refractive index layer is made of material with a refractive index less than 1.6.

The high refractive index layer may be made of metal oxide. For example, the high refractive index layer is preferably made of at least one of In₂O₃, SnO₂, ZnO and ITO, or an alloy of thereof, or made of transparent conductive material doped with Al or Ga in ZnO. Alternatively, the high refractive index layer is preferably made of at least one of TiO₂, Nb₂O₅, ZrO₂, and Ta₂O₅. The low refractive index material may include, for example, MgF₂, AlF₃, and SiO₂.

The method of forming the translucent layer 133 on a main surface of the substrate layer 131 may use a dry process such as vapor deposition, sputtering, and chemical vapor deposition (CVD). By appropriately selecting the material and thickness of each layer of the laminated structure made of the high and low refractive index layers, it is possible to obtain the translucent layer 133 having the desired reflectance (transmittance).

In the example described above, although there has been described the example in which the translucent mirror 13 is manufactured by forming the translucent layer 133 on a main surface of the substrate layer 131, the translucent mirror 13 may further include an infrared cut filter, an anti-reflective layer, or the like. In this case, the anti-reflective layer is preferably formed on the surface of main surfaces of the substrate layer 131 on which the translucent layer 133 is not formed.

By forming the anti-reflective layer on the surface of main surfaces of the substrate layer 131 on which the translucent layer 133 is not formed, multiple internal reflection in the translucent mirror 13 is suppressed. By suppressing the multiple internal reflections in the translucent mirror 13, it is possible to suppress the unwanted reflected glare of the image obtained by photographing which would not exist originally.

Further, by forming the anti-reflective layer on the surface of main surfaces of the substrate layer 131 on which the translucent layer 133 is not formed, the membrane stress due to the forming of the translucent layer 133 on the substrate layer 131 is alleviated, thereby reducing warping of the translucent mirror 13. This is considered because the membrane stress caused by the translucent layer 133 is offset against the membrane stress caused by the anti-reflective layer. In addition, as used herein, the term “warping” refers to include not only a one-dimensional bending but also a two-dimensional distortion.

FIG. 4B and FIG. 4C are schematic diagrams illustrating the influence of warping of the translucent mirror on the travelling direction of light reflected by the translucent mirror.

FIG. 4B and FIG. 4C illustrate schematic cross-sectional views of the translucent mirror taken along a plane including the vertical direction of the imaging device. As shown in FIG. 4B, if a translucent mirror 13p is assumed to be planar, then the subject light is incident on the translucent mirror 13p at an angle of −α with respect to the normal NA to the translucent mirror 13p. In the case, the travelling direction of a reflected light forms an angle of α with respect to the normal NA.

As shown in FIG. 4C, it is assumed that there is a large amount of warping in a translucent mirror 13w and the translucent mirror 13w has an arcuate cross section. In addition, the normal NB to the tangent plane on which the subject light is incident is assumed to form an angle of −β with the normal NA. At this time, the light is reflected in the direction shifted by an angle of −2β with respect to the reflected light shown in FIG. 4B. As shown in FIG. 4C, the translucent mirror 13w has a convex shape with respect to the light incident surface, but the same is also true when the translucent mirror 13w has a convex shape with respect to the light emitting surface.

In this way, if the translucent mirror is largely warped, the warping of the translucent mirror has a significant influence on the travelling direction of light reflected by the translucent mirror.

For example, if the arrangement positions of the image generator 11 and the image sensor 15 are replaced with each other, then the imaging is performed by the light of the subject light which is reflected by the translucent mirror 13.

In this case, as compared with the case where the imaging is performed by the light reflected by the translucent mirror 13, the image formation position of image related to the subject is deviated, and thus the image quality related to the image obtained by photographing is deteriorated. In particular, when the image sensor 15 is disposed in the imaging portion 75, the image data obtained by the imaging is electronic data which is easily expanded by a computer, and thus the deviation of the image formation position is likely to be a problem for the user.

Thus, according to the embodiment of the present disclosure, the one or more lenses 731, the translucent mirror 13, and the image sensor 15 are arranged substantially in a row along the optical axis OA of the subject light. In other words, in the embodiment of the present disclosure, the one or more lenses 731, the translucent mirror 13, and the image generator 11 are not arranged substantially in a row along the optical axis OA of the subject light. By performing the imaging by allowing the light transmitted through the translucent mirror 13 among the subject light to be incident on the image sensor 15, it is possible to suppress the deterioration of image quality of the image obtained by photographing, which is caused by warping of the translucent mirror.

On the other hand, when the translucent mirror is warped, there may be some deviation in the travelling direction of the light that is emitted from the image generator 11 and then reflected by the translucent mirror, but the influence of warping of the translucent mirror on the image projected on a screen or the like is small. This is because the impression of the deviation of image projected on a screen or the like on the user is relatively small as compared to the case of displaying the image data on a monitor screen of the computer.

Therefore, the influence of warping of the translucent mirror on the projection of the projection image can be reduced as compared to the influence of warping of the translucent mirror on the photographing. That is, there is no problem in using the light reflected by the translucent mirror 13 for the projection of the projection image.

In addition, when the light reflected by the translucent mirror 13 is used for autofocus at the time of photographing, the flatness of the translucent mirror 13 is improved, thereby increasing the accuracy of reflection angle and improving autofocus performance of the imaging device 10.

[1-3. Exemplary Process Performed by Imaging Device]

In accordance with the embodiment of the present disclosure, the image generator 11 includes one or more light sources 115. The one or more light sources 115 of the image generator 11 is preferably illuminated at the time of photographing so that light emitted from the one or more light sources 115 has no influence on photographing.

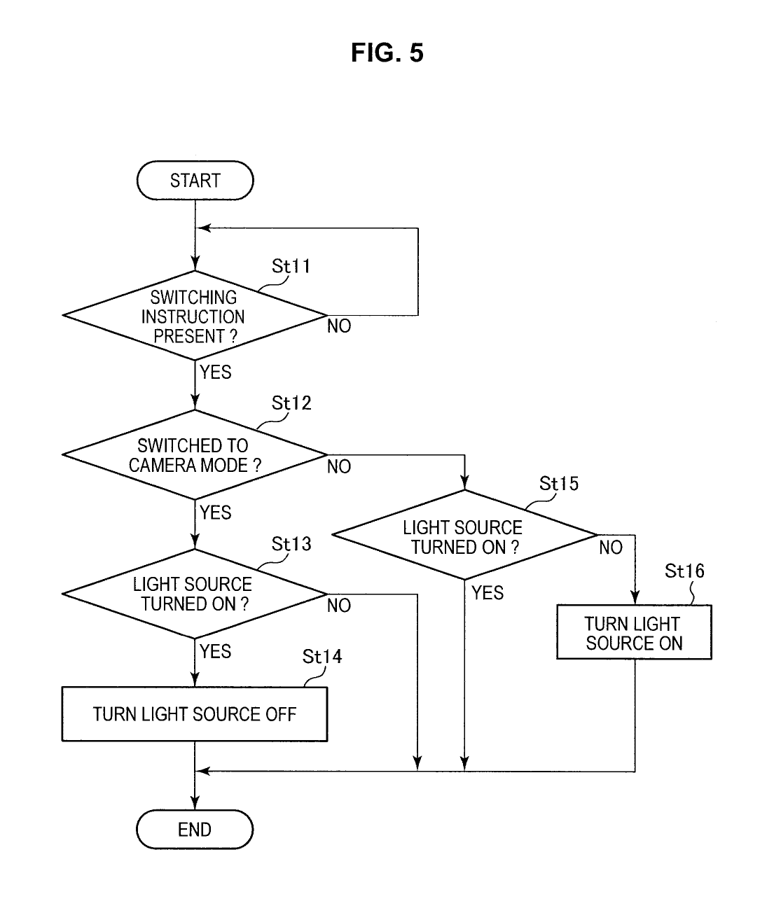

FIG. 5 is a flowchart illustrating an exemplary process of mode switching performed in an imaging device according to the embodiment of the present disclosure.

For example, the imaging device 10 is assumed to have two modes, the one is a camera mode for obtaining an image signal related to the subject, and the other is a projector mode for projecting a projection image. These two modes can be switched with each other by allowing a user to operate the operating portion 77. A series of processes to be described below with reference to FIG. 5 may be performed, for example, by the controller 19 described above.

In step St11, it is determined whether there is an input for switching the mode. If it is determined that there is no input for switching the mode, then the process is returned. On the other hand, If it is determined that there is the input for switching the mode, then the process proceeds to step St12.

Next, in step St12, it is determined whether any one of the modes is selected by the user. If it is determined that switching to the camera mode is selected by the user, then the process proceeds to step St13. In step S13, it is determined whether the one or more light sources 115 of the image generator 11 are on. If it is determined that the one or more light sources 115 are on, then, the process proceeds to step St14. In step St14, the one or more light sources 115 are turned off. If it is determined that the one or more light sources 115 are off, then the process is terminated.

On the other hand, if it is determined that switching to the projector mode is selected by the user, then the process proceeds to step St15. In step St15, it is determined whether the one or more light sources 115 of the image generator 11 are on. If it is determined that the one or more light sources 115 are off, then, the process proceeds to step St16. In step St16, the one or more light sources 115 are turned on. If it is determined that the one or more light sources 115 are on, then the process is terminated.

In this way, the on/off of the one or more light sources 115 of the image generator 11 may be controlled automatically depending on the mode selection by the user. In addition, when the user selects the projector mode, the display portion 17 may be turned off, or the incidence of light on the image sensor 15 may be blocked by a focal-plane shutter disposed in front of the image sensor 15. In this way, it is possible to prevent the display portion 17 from displaying an unwanted image at the time of the projector mode. In addition, depending on the user's selection of the modes, the turning on/off of the one or more light sources 115 of the image generator 11 or the turning on/off of the display portion 17 can be controlled, thereby reducing the excessive consumption of power for operating the imaging device 10.

[1-4. Effect]

In accordance with the embodiment of the present disclosure, the photographing or projection is performed through the fixed translucent mirror, and thus it is not necessary for an image forming optical system for photographing and an image forming optical system for projection to be provided separately.

On the other hand, in accordance with the related art in which the image forming optical system for photographing and the image forming optical system for projection are provided separately within the imaging device, these two optical systems are independent of each other, thereby increasing the number of the components. In addition, because the photographing function and the projecting function are independent, no matter how these two optical systems are arranged, it is extremely difficult for the lens for image formation to be used in common for both photographing and projecting. Therefore, in the method according to the related art in which two independent optical systems are provided, if the function of a projector is added to the imaging device, then the imaging device will increase in size or weight.

Unlike the related art, in accordance with the embodiment of the present disclosure, the photographing and projection functions are performed through the translucent mirror, and thus it is possible to add the function as a projector to the imaging device without significantly changing the size of the camera with a known pellicle mirror.

Furthermore, in the translucent mirror, by appropriately selecting the material and thickness of each layer of the translucent layer which is a laminated structure, it is possible to appropriately tune reflectance or transmittance of incident light according to the specifications of the image generator or the image sensor. For example, the luminance of a screen or the like can be sufficiently maintained at the time of projection of the projection image while maintaining the amount of light incident on the image sensor at the time of photographing. Therefore, in accordance with the embodiment of the present disclosure, the degree of freedom in the design of the imaging device is improved.

Moreover, it is possible to manufacture a lightweight, compact translucent mirror as compared to the case of using a prism or the like. Thus, by allowing light passing through the translucent mirror among the subject light to be incident on the image sensor, an optical path length within the translucent mirror can be reduced, thereby suppressing the deterioration of image quality of the image obtained by photographing.

In accordance with the first embodiment of the present disclosure, the translucent mirror is fixed inside the housing of the main body. Thus, there is no portion to be mechanically operated at the time of switching between photographing and projection, and thus there is no generation of dust inside the imaging device. In addition, because it is not necessary to provide a mechanism for shifting the translucent mirror, the image pickup device provided with the function as a projector can be made more compact.

In accordance with the embodiment of the present disclosure, the lens unit is used in common for both photographing and projecting. Thus, in accordance with the embodiment of the present disclosure, it is not necessary to provide separately the lens unit used for photographing and the lens unit used for projection. Further, in accordance with the embodiment of the present disclosure, the user can select the optimum lens unit for photographing or projecting among various types of lens units such as a short focus lens, a wide angle lens, and a telephoto lens.

In this way, in accordance with the embodiment of the present disclosure, an image forming optical system including the translucent mirror is used in common in the two modes, namely a camera mode and a projector mode. Thus, as compared with the case in which the image forming optical system for photographing and the image forming optical system for projection are provided as individual components, the number of the components can be reduced, and thereby lowering manufacturing costs of the imaging device provided with the function as a projector. Consequently, in accordance with the embodiment of the present disclosure, it is possible to provide a compact, portable imaging device capable of projecting the image obtained by photographing and thus allowing many people to view the image.

### 2. Second Embodiment

[2-1. General Configuration of Imaging Device]

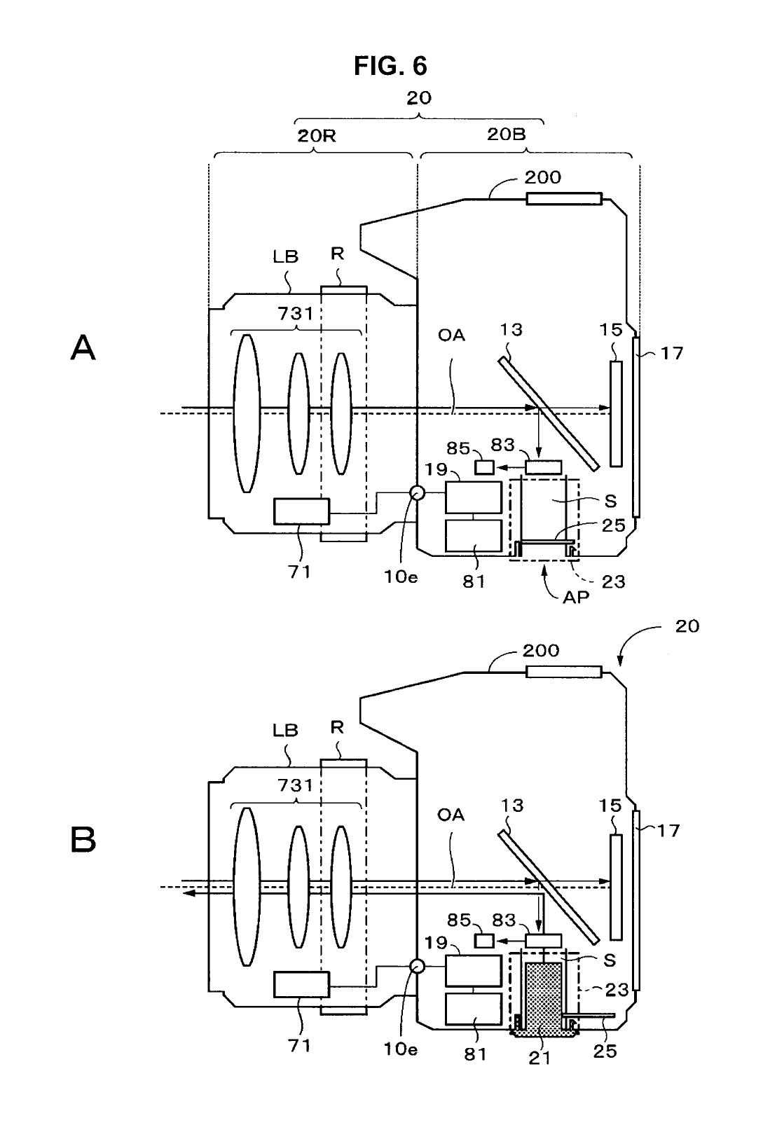

FIG. 6A is a diagram schematically illustrating an exemplary configuration of an imaging device according to a second embodiment of the present disclosure. FIG. 6B is a schematic diagram illustrating the imaging device shown in FIG. 6A having a projector unit connected thereto. FIGS. 6A and 6B correspond to diagrams viewed from the right side of the imaging device according to the second embodiment.

Note that structural elements that have substantially the same configuration as the first embodiment are denoted with the same reference numerals as those of the first embodiment.

The imaging device 20 according to the second embodiment is similar to the first embodiment in that the imaging device 20 includes a translucent mirror 13 and an image sensor 15. The imaging device 20 according to the second embodiment is different from the first embodiment in that the imaging device 20 includes a connecting portion 23 to which a projector unit may be connectable and detachable. The projector unit is used to generate a projection image. The connecting portion 23 is shown by broken lines in FIG. 6A and FIG. 6B. The projector unit 21 connected to the connecting portion 23 is shown by half-tone dot meshing in FIG. 6B.

As shown in FIG. 6B, for example, in a case where the projector unit 21 is connected to a main body 20B of the imaging device 20, one or more lenses 731 of a lens unit 20R, the translucent mirror 13, and the image sensor 15 are arranged substantially in a row along an optical axis OA of a subject light. Further, in a case where the translucent mirror 13 is fixed inside a housing 200 of the main body 20B so that the translucent mirror 13 is inclined at an angle of, for example, about 45° with respect to the optical axis OA of the subject light, if the projector unit 21, the translucent mirror 13, and the image sensor 15 are connected in sequence, then they form nearly a right angle.

In other words, in the imaging device 20 according to the second embodiment, the image sensor 15, when receiving an image signal related to a subject, receives light which is transmitted through the translucent mirror 13 among the subject light. On the other hand, in a state in which the projector unit 21 is connected to the imaging device 20, at least a portion of light emitted from the projector unit 21 is reflected by the translucent mirror 13 and the reflected light is emitted toward the outside of the housing 200.

In the second embodiment, the imaging device 20 includes the connecting portion 23 to which the projector unit can be connectable and detachable. In accordance with the second embodiment, both photographing and projection are performed through the fixed translucent mirror 13, and thus it is possible to allow the imaging device 20 to function as a projector, which is substantially similar to the case of the first embodiment.

(2-1-1. Connecting Portion)

The connecting portion 23 is a mechanism for connecting with the projector unit 21 to be described later. As shown in FIG. 6A, the connecting portion 23 is provided, for example, on the bottom surface of the housing 200 of the main body 20B.

In order to provide the connecting portion 23, as shown in FIG. 6A, for example, an opening AP is formed in the bottom surface of the main body 20B, and a space S is formed between the opening AP and the optical path switching unit 83 or the translucent mirror 13 inside the housing 200 of the main body 20B. In addition, a lid portion 25 is provided in the bottom surface of the housing 200 of the main body 20B. The lid portion 25 is used to prevent dirt and dust from entering into the housing 200 through the opening AP. In a state where the lid portion 25 is opened, for example, the user can visually recognize the optical path switching unit 83 through the opening AP. Moreover, for example, the user can visually recognize the translucent mirror 13 which is fixed inside housing 200 of the main body 20B through the opening AP.

In this embodiment, as shown in FIG. 6A and FIG. 6B, the space S provided inside housing 200 is formed as a slot for allowing the projector unit to be inserted. In a state where the projector unit 21 is connected to the main body 20B of the imaging device 20, as indicated by the arrows in FIG. 6B, the light related to the projection image emitted from the projector unit 21 is incident on the translucent mirror 13 through the space S.

For example, a boss, a hooked portion, or the like is formed in a housing 210 of the projector unit 21. The boss or hooked portion is used to fasten the housing 210 of the projector unit 21 to the main body 20B of the imaging device 20. Thus, a recessed portion or the like corresponding to the boss or hooked portion of the housing 210 of the projector unit 21 is formed in the housing 200 of the main body 20B. The boss or hooked portion formed in the housing 210 of the projector unit 21 is fitted into the recessed portion formed in the housing 200 of the main body 20B. Therefore, the projector unit 21 inserted into the space S is fixed to the main body 20B and thus the projector unit 21 is connected to the connecting portion 23.

In addition, the connecting portion 23 is provided with a connector for communicating with the controller 19, and, as necessary, is provided with a connector for delivering power from a power supply of the main body 20B. For example, the projector unit 21 exchanges signals or data with the controller 19 through these connectors.

(2-1-2. Projector Unit)

The projector unit 21 is an auxiliary device that adds a function as a projector to the imaging device 20. The projector unit 21 generates a projection image to be played back it on a screen or wall surface in a similar manner to the image generator 11 described above.

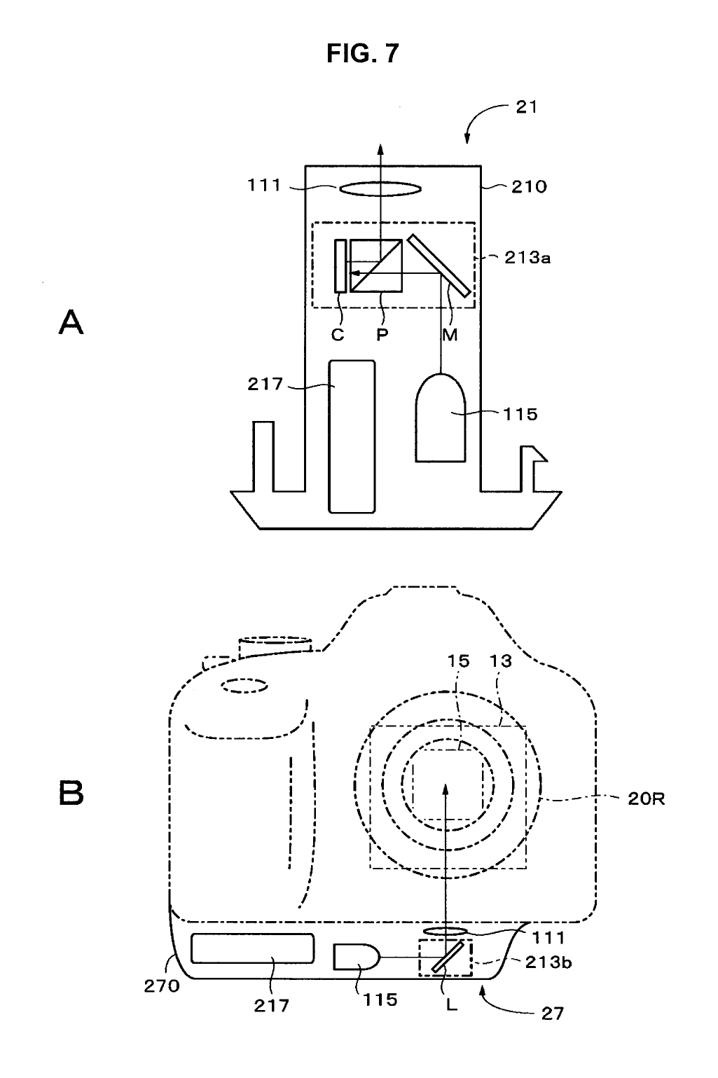

FIG. 7A is a diagram schematically illustrating an exemplary configuration of the projector unit shown in FIG. 6B.

The housing 210 of the projector unit 21 is formed, for example, in a substantially rectangular parallelepiped or cylindrical shape as a whole. The housing 210 of the projector unit 21 may have the same configuration as the image generator 11 described above.

In other words, as shown in FIG. 7A, the projector unit 21 includes one or more light sources 115, and, as necessary, further includes one or more lenses 111. In addition, as shown in FIG. 7A, the projector unit 21 may include a power supply 217. The projector unit 21 may be operated with power supplied from the power supply 217. Alternatively, the power supply 217 of the projector unit 21 may be used as an auxiliary power supply of the imaging device 20.

Further, the projector unit 21 includes an image information superimposition part 213a composed of one or more liquid crystal displays, a “DLP” (registered trademark) chip, and so on. FIG. 7A shows an exemplary configuration of the image information superimposition part 213a composed of a mirror M, a prism P, a “DLP” (registered trademark) chip, and so on. For example, the image information superimposition part 213a is interposed between the one or more light sources 115 and the one or more lenses 111. By this arrangement, image information related to the projection image is superimposed onto the light emitted from the one or more light sources 115, and thus the light onto which image information related to the projection image is superimposed is emitted from the projector unit 21.

The light emitted from the projector unit 21 is incident on the translucent mirror 13 fixed inside the housing 200 of the main body 20B in the imaging device 20. At least a portion of light relevant to the projection image, which is generated and emitted by the projector unit 21 is reflected by the translucent mirror 13 fixed inside the housing 200 of the main body 20B in the imaging device 20, and then the reflected light is emitted toward outside of the housing 200 through the one or more lenses 731 of the lens unit 20R. The light emitted toward outside of the housing 200 is image-formed, for example, on a screen, and then the user can view the projection image as substantially similar to the case of the first embodiment.

FIG. 7B is a diagram schematically illustrating another exemplary configuration of the projector unit. FIG. 7B corresponds to a view illustrating the projector unit connected to the imaging device according to the second embodiment, which is viewed from the front side of the imaging device.

As shown in FIG. 7B, the light related to the projection image may be reflected by a reflective member disposed inside the housing 270 of the projector unit 27, and then the reflected light may be incident on the translucent mirror 13. For example, as shown in FIG. 7B, the light emitted from the one or more light sources 115 may be travelled along the lateral direction when viewed from the front of the imaging device. In this case, the light may be reflected by a reflective liquid crystal display L or the like of the image information superimposition part 213b and then may be travelled toward the translucent mirror 13.

In this case, the light emitted from the one or more light sources 115 may be travelled along the lateral direction when viewed from the front of the imaging device and then may be travelled toward the translucent mirror 13. This makes it possible to reduce the thickness of the projector unit 27, thereby reducing the vertical thickness of the imaging device. Therefore, since the optical path may be bent by disposing a reflective member such as a reflective liquid crystal display or a mirror inside the housing of the projector unit, even when the projector unit is mounted on the imaging device, the appearance of the imaging device may be designed without impairing integrity of the imaging device. In addition, at this time, it is not necessary to provide a large space inside the housing of the main body of the imaging device.

[2-2. Exemplary Process Performed by Imaging Device]

In the second embodiment, the projector unit is adapted to be connectable to and detachable from the imaging device. Thus, when the user wants to take a photograph only, the user can carry the imaging device by simply removing the projector unit from the imaging device. In other words, in accordance with the second embodiment, it is possible to provide a lightweight, highly portable imaging device. Of course, even when the projector unit is attached to the imaging device, the user may take a photograph using the imaging device to which the projector unit is attached.

There may be a case where the user wants to project an image obtained by photographing or the like using the imaging device to which the projector unit is attached. In particular, after the user takes a photograph using the imaging device, the user may be more likely to try to project an image obtained by photographing or the like, while keeping power of the imaging device turned on and keeping the projector unit attached to the imaging device.

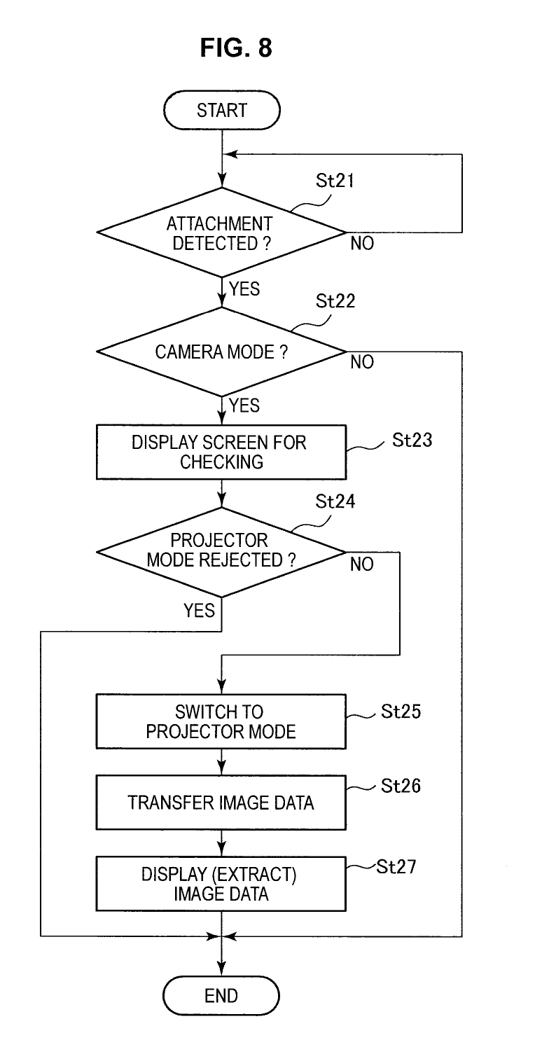

FIG. 8 is a flowchart illustrating an exemplary process performed by the imaging device according to the second embodiment of the present disclosure.

For example, the imaging device 20 is assumed to have two modes, namely a camera mode and a projector mode. A screen displayed on the display portion 17 of the imaging device may be changed to a setting screen for mode switching by connecting the projector unit to the imaging device 20. A series of processes to be described below with reference to FIG. 8 may be performed, for example, by the controller 19.

For example, the imaging device 20 is assumed to keep the power on.

First, in step St21, it is determined whether the projector unit 21 is attached to the imaging device 20. The detection of whether the projector unit 21 is attached to the imaging device 20 may be done using an electrical or magnetic way. Alternatively, the detection of whether the projector unit 21 is attached to the imaging device 20 may be done using a mechanical way.

If it is determined that the projector unit 21 is not attached to the imaging device 20, then the process is returned. On the other hand, if it is determined that the projector unit 21 is attached to the imaging device 20, the process proceeds to step St22.

Next, in step St22, it is determined whether the imaging device 20 is in the camera mode. If it is determined that the imaging device 20 is in the camera mode and the projector unit 21 is attached to the imaging device 20 while keeping the power on, then it is determined that the user attempts to project the projection image. Then, the process proceeds to step St23. On the other hand, if is determined that imaging device 20 is not in the camera mode, since the imaging device 20 is in the projector mode, thus the process is terminated.

Next, in step St23, a screen displayed on the display portion 17 is changed into a screen which allows the user to check whether the imaging device 20 may be switched to the projector mode.

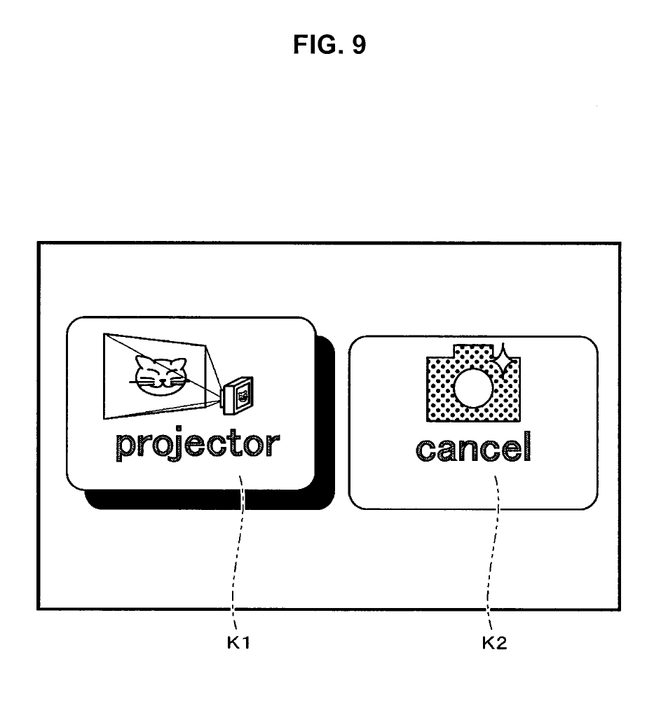

FIG. 9 is an image view illustrating an exemplary screen for allowing a user to check whether the imaging device may be switched to the projector mode.

FIG. 9 shows an example of an image that displays an icon K1 which is selected when the switching to the projector mode is accepted and an icon K2 which is selected when the switching to the projector mode is wanted to be cancelled. In step St23, the imaging device 20 may be switched to the projector mode in a forced manner, but as in this example, it may be possible for the user to cancel the forced switching to the projector mode, thereby improving the user convenience.

In step St23, the screen for allowing the user to check whether the imaging device 20 may be switched to the projector mode is displayed on the display portion 17. Then, the process proceeds to step St24.

Next, in step St24, it is determined whether the user has cancelled the switching to the projector mode. More specifically, if the user selects the icon K2, this means that the user wished to continue to take photographs, and thus the process is terminated. On the other hand, if the user selects the icon K1, the process proceeds to step St25.

Next, in step St25, the imaging device 20 is switched to the projector mode. Specifically, for example, the light is blocked from entering to the image sensor 15 by a focal plane shutter disposed in front of the image sensor 15. Alternatively, for example, the one or more light sources 115 disposed in the projector unit 21 are turned on.

Next, in step St26, image data is read out from the storage portion 81, and transfer of the image data from the controller 19 to the projector unit 21 is initiated.

Next, in step St27, for example, the image data is displayed as a thumbnail on the display portion 17. Then, all processes are terminated. Alternatively, in step St27, for example, the image data may be projected as a thumbnail on a screen.

In this case, in step St27, the image data may be displayed in a time series by extracting the image data acquired most recently from a plurality of image data, or image data may be displayed in the order of the number of times being played back. The image which is more likely to be projected by the user may be preferentially displayed, thereby improving the user convenience.

Further, in the process described above, although the example of allowing the user to check whether the imaging device 20 may be switched to the projector mode has been described in step St23 and step St24, the process of mode switching in the imaging device 20 is not limited to this example. For example, in a case where automatic switching to the projector mode is previously permitted by the user when the projector unit 21 is attached to the imaging device 20, by reading the setting defined by the user, steps St23 and St24 may be skipped.

Moreover, for example, when it is detected that the projector unit 21 is attached to the imaging device 20 or when the user inputs an instruction for switching to the projector mode, it may be configured to initiate the transfer of the image data to the projector unit 21. This makes it possible for the user to project immediately the projection image on a screen or the like.

[2-3. Effect]

Similarly to the first embodiment, in the second embodiment, an image forming optical system having the translucent mirror is used in common in two modes, namely a camera mode and a projector mode. For this reason, according to the second embodiment, it is possible to obtain the same effect as the first embodiment. Further, in the second embodiment, since the projector unit is connectable to and detachable from the imaging device by using the connecting portion, it is possible to cause the imaging device to function as a projector without any significant modification to the configuration of the existing imaging device.

### 3. Third Embodiment

[3-1. General Configuration of Imaging Device]

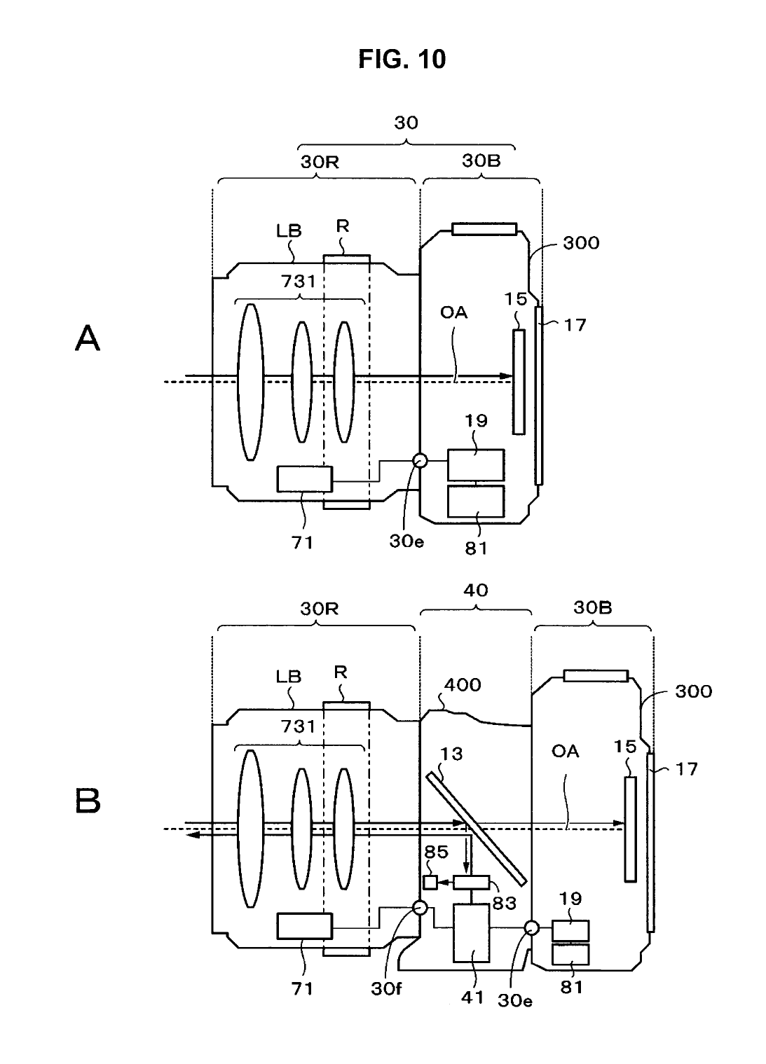

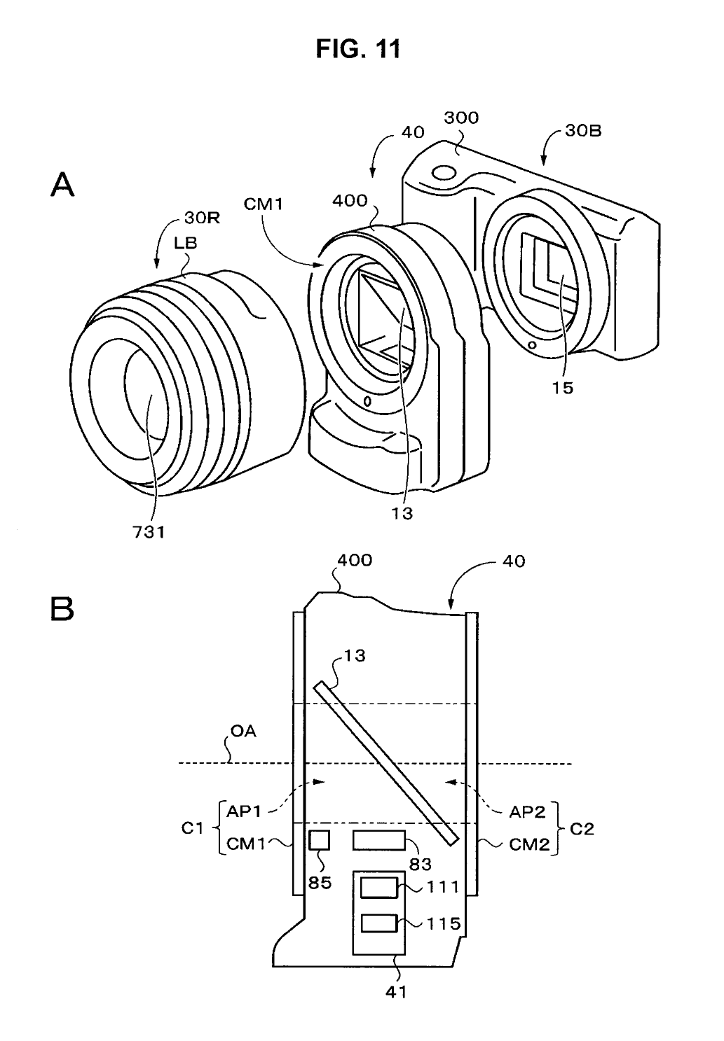

FIG. 10A is a diagram schematically illustrating an exemplary configuration of an imaging device according to a third embodiment of the present disclosure. FIG. 10B is a diagram schematically illustrating the imaging device having a projector unit attached between the main body and the lens unit of the imaging device. FIG. 11A is an exploded perspective diagram of the imaging device which is divided into a lens unit, a projector unit, and a main body. FIG. 10A corresponds to a diagram of the imaging device according to the third embodiment, which is viewed from the right side of the imaging device. FIG. 10B corresponds a diagram of the imaging device and a projector unit according to the third embodiment, which is viewed from the right side of the imaging device.

An imaging device 30 according to the third embodiment is the same as the imaging device 10 according to the first embodiment in that the imaging device 30 includes a translucent mirror 13 in a main body 30B. The third embodiment is different from the first embodiment in that the imaging device 30 includes a lens unit 30R which is connectable to and detachable the main body 30B and a projector unit 40 is connectable and detachable between the main body 30B and the lens unit 30R.

In the third embodiment, the lens unit 30R includes one or more lenses 731, and the projector unit 40 includes the translucent mirror 13. As shown in FIG. 10B, in a state where the projector unit 40 is connected between the main body 30B and the lens unit 30R, the lens unit 30R, the translucent mirror 30, and an image sensor 15 are arranged substantially in a row along an optical axis OA of a subject light. In this case, the translucent mirror 13 is fixed inside a housing 400 of the projector unit 40 so that the translucent mirror 13 is inclined at an angle of, for example, about 45° with respect to the optical axis OA of the subject light. Thus, if an image generator 41 of the projector unit 40, the translucent mirror 13, and the image sensor 15 are connected to each other with a virtual line, then the line forms substantially a right angle.

In other words, similarly to the first and second embodiments, in the imaging device 30 according to the third embodiment, at the time of acquisition of the image signal related to the subject, the image sensor 15 receives light which is transmitted through the translucent mirror 13 among the subject light. In addition, in a state where the projector unit 40 is connected to the imaging device 30, the translucent minor 13 reflects at least a portion of light emitted from the image generator 41 of the projector unit 40 and emits the reflected light to the outside of the housing 400 of the projector unit 40.

In the third embodiment, the projector unit 40 having the translucent mirror 13 is connectable and detachable between the main body 30B and the lens unit 30R. In accordance with the third embodiment, both photographing and projection are performed through the fixed translucent minor 13, and thus it is possible to allow the imaging device to function as a projector, which is similar to the case of the first and second embodiments. In other words, in accordance with the third embodiment, even when the imaging device is not provided with a mirror (including a movable minor in addition to the translucent minor) in front of the image sensor, it is possible to add a function as a projector to the imaging device.

(3-1-1. Imaging Device)

As shown in FIG. 10A, the imaging device 30 according to the third embodiment is composed, for example, of the main body 30B and the lens unit 30R. Thus, the imaging device 30 shown in FIG. 10A is different from the first and second embodiments in that the light transmitted through one or more lenses 731 of the lens unit 30R is incident on the image sensor 15 without passing through the translucent minor.

In this way, the imaging device 30 shown in FIG. 10A is not include a flip-up minor, a translucent minor or the like inside the housing 300 of the main body 30B, specifically it is a digital camera called as a “mirrorless interchangeable lens camera”. The mirrorless interchangeable lens camera has advantage of a compact camera with a small structure capable of allowing the user to take a photograph easily and has advantage of a single-lens reflex camera capable of replacing lens according to the scene and representing it in various ways.

As described above, the lens unit 30R is connectable to and detachable from the main body 30B. Therefore, in the third embodiment, when the user projects image data onto a screen or the like, the projector unit 40 can be connected between the main body 30B and the lens unit 30R. In addition, an electrical contact 30e may be provided between the main body 30B and the projector unit 40, as necessary. Similarly, an electrical contact 30f is provided between the projector unit 40 and the lens unit 30R, as necessary.

(3-1-2. Projector Unit)

FIG. 11B is a diagram schematically illustrating an exemplary configuration of the projector unit connected between the main body and the lens unit. FIG. 11B corresponds to a diagram illustrating the projector unit viewed from the right side of the imaging device in a state where the projector unit is connected to the imaging device according to the third embodiment.

As shown in FIG. 11B, the projector unit 40 includes the housing 400, the translucent mirror 13, and the image generator 41.

An opening AP1 is formed in a surface to which the lens unit 30R of the imaging device 30 is connected inside the housing 400 of the projector unit 40. A connecting mechanism CM1 which is used to be connectable to and detachable from the lens unit 30R is provided in the periphery of the opening AP1. A set of the opening AP1 and the connecting mechanism CM1 will be appropriately referred to as a first connecting portion C1.

On the other hand, an opening AP2 is formed in a surface to which the main body 30B of the imaging device 30 is connected inside the housing 400 of the projector unit 40. A connecting mechanism CM2 which is used to be connectable to and detachable from the main body 30B is provided in the periphery of the opening AP2. A set of the opening AP2 and the connecting mechanism CM2 will be appropriately referred to as a second connecting portion C2.

As shown in FIG. 11B, the translucent mirror 13 is disposed between the first connecting portion C1 and the second connecting portion C2 within the housing 400 of the project unit 40. The user can visually recognize the translucent mirror 13 fixed inside the housing 400 of the projector unit 40 through the first connecting portion C1 or the second connecting portion C2. In addition, as shown in FIG. 11B, the translucent mirror 13 is fixed inside the housing 400 of the projector unit 40 so that the translucent mirror 13 is inclined with respect to the optical axis OA of the subject light.

The image generator 41 disposed in the housing 400 of the projector unit 40 has the same configuration as the image generator 11 described above. In other words, as shown in FIG. 11B, the image generator 41 includes one or more light sources 115, and further includes one or more lenses 111, as necessary. In addition, a controller 19 may supply signals or image data to the image generator 41 of the projector unit 40 through the second connecting portion C2. The projector unit 40 may be provided with a power supply in the housing 400.

An autofocus sensor 85 may be provided within the housing 400 of the projector unit 40, as necessary. Specifically, the autofocus sensor 85 is a sensor that employs a phase difference detection method.

[3-2. Imaging Device Having Projector Unit Connected Thereto]

In a state where the projector unit 40 is connected between the main body 30B and the lens unit 30R, the imaging device having the projector unit 40 connected thereto has substantially the same configuration as the imaging device 10 according to the first embodiment.

In other words, when an image signal related to a subject is obtained, at least a portion of the subject light is reflected by the translucent mirror 13 and the rest transmits through the translucent mirror 13. The light transmitted through the translucent mirror 13 is incident on the image sensor 15 and then the image sensor 15 outputs the image signal related to the subject.

On the other hand, the light reflected by the translucent mirror 13 is guided, for example, to the autofocus sensor 85 through an optical path switching unit 83 disposed within the housing 400, as necessary. The autofocus sensor 85 is disposed below the housing 400 with respect to the translucent mirror 13. Thus, in a state where the projector unit 40 is connected between the main body 30B and the lens unit 30R, the user can cause the imaging device to perform an autofocus function that employs a phase difference detection method.

In the imaging device 30 shown in FIG. 10A, the subject light is incident on the image sensor 15 without passing through the translucent mirror. For this reason, in general, the autofocus is performed in the imaging device 30 based on a contrast detection method which uses light incident on the image sensor 15. The contrast detection method is less expensive because of a relatively simple configuration. The contrast detection method has advantage of scanning the entire angle, while it has disadvantage of taking a long time to adjust the focus because the focus is adjusted by shifting the lens.

Therefore, as shown in FIG. 11B, the autofocus sensor 85 which employs the phase difference detection method is disposed inside the housing 400 of the projector unit 40, this makes it possible for the user to cause the imaging device to perform a high-speed autofocus function. In other words, it is possible to cause the imaging device to perform a high-speed autofocus function based on the phase difference detection method without having to embed a sensor employing the phase difference detection method in the image sensor 15.

Further, the autofocus to be used may be switched to any one of the phase difference detection autofocus and the contrast detection autofocus according to the environment at the time of photographing. For example, the detection method for autofocus may be switched to a detection method according to the environment at the time of photographing based on the control of the controller 19 or the input operation from the user.

Moreover, the translucent mirror 13 reflects at least a portion of light emitted from the image generator 41 and emits the reflected light to the outside of the housing 400. Specifically, in this example, the light, which is emitted from the image generator 41, related to the projection image is emitted to the outside of the imaging device through the translucent mirror 13, the first connecting portion C 1, and one or more lenses 731 of the lens unit 30R. When the light emitted to the outside of the housing 400 is image-formed on a screen, the user can view the projection image, as similar to the cases of the first and second embodiments.

(3-2-1. Standards of First and Second Connecting Portions)

A mechanism which is used to connect between the main body of the imaging device and the lens unit may be referred to as a “mount”. The mount has a number of standards. For this reason, when the standard of the mount in the lens unit is different from the standard of the mount in the main body, it is difficult to connect the lens unit to the main body by the user.

However, for example, there may be a various types of lens units which include a mount having a standard different from that of a mount of a main body of an imaging device owned by the user. Therefore, it is also necessary to combine a main body including a mount having a certain standard with a lens unit including a mount having a standard different from the standard of the mount of the main body.

Thus, in the housing 400 of the projector unit 40, a connecting mechanism disposed in the surface which is connected to the lens unit of the imaging device and a connecting mechanism disposed in the surface which is connected to the main body of the imaging device may be configured to correspond to different standards. Specifically, the first connecting portion C 1 and the second connecting portion C2 includes respective mounts corresponding to theirs individual different standards, and thus the projector unit 40 can function as an adaptor for converting the standard of the mount. Consequently, in accordance with the third embodiment, it is possible to allow the projector unit to function as an adaptor for converting the standard of the mount, thereby responding to a wide range of user needs.

[3-3. Exemplary Control performed by Imaging Device]

In the third embodiment, the projector unit is configured to be connectable to and detachable from the imaging device, as similar to the case of the second embodiment. Thus, when the user connects the projector unit 40 between the main body 30B and the lens unit 30R, it may be considered that the user wants to project the image obtained by photographing or the like.

In this case, as described above with reference to the FIG. 8 and FIG. 9, for example, a screen displayed on the display portion 17 of the imaging device may be switched by connecting the projector unit 40 to the main body 30B. Specifically, for example, after the user takes a photograph using the imaging device 30, when the user connects the projector unit 40 to the main body 30B without turning the power of the imaging device off, it is possible to allow a setting screen for switching the mode to be displayed on the display portion 17.

Furthermore, for example, when it is detected that the projector unit 40 is connected to the main body 30B or when the user inputs an instruction for switching to the projector mode, it may be configured to initiate the transfer of the image data to the projector unit 40.

[3-4. Effect]

In the third embodiment, similarly to the first and second embodiments, the one or more lenses of the lens unit and the translucent mirror are used in common in two modes of a camera mode and a projector mode. For this reason, in accordance with the third embodiment, it is possible to obtain the same effect as the first and second embodiments.

In addition, in accordance with the third embodiment, it is possible for the mirrorless interchangeable lens camera to function as a projector without any modification to the configuration of the existing mirrorless interchangeable lens camera. Further, the user can use the imaging device according to the third embodiment as a mirrorless interchangeable lens camera or as a digital camera with a pellicle mirror, as necessary.

When the first connecting portion C1 and the second connecting portion C2 include respective mounts corresponding to theirs individual different standards, the user can use the projector unit 40 to function as an adaptor for converting the standard of each of the mounts.

As described above, in accordance with the embodiments of the present disclosure, since both photographing and projection are performed through the translucent mirror, the photographing and projection can be realized by a single lens unit. In the embodiments of the present disclosure, since both photographing and projection can be realized by a single lens unit, it is possible to add a function as a projector to the imaging device while suppressing the increase in size and the increase in the number of components of the imaging device. In this way, in accordance with the embodiments of the present disclosure, it is possible to provide a lightweight, highly portable imaging device capable of both photographing and projection with no extra apparatus, also it is possible to provide a simple method of allowing the image obtained by photographing to be shared by many people.

### 4. Modifications

While the preferred embodiments have been described above, preferred specific details are not limited to the above embodiments, and various modifications are possible.

In the embodiment described above, although a digital camera is illustrated as the imaging device, the present disclosure is not limited this example. The embodiments of the present disclosure are applicable to electronic equipment provided with an image sensor. The embodiments of the present disclosure are applicable, for example, to video cameras, smart phones, mobile phones, electronic books, personal computers (tablet, laptop, desktop), personal digital assistances (PDAs), video game consoles, and so on.

Further, in the embodiments described above, the imaging device is described by way of example as being a digital imaging device. However, even when the imaging portion is made of film, the technologies of the present disclosure may be applicable. In this case, the projection image is generated from image data supplied from the outside of the imaging device.

The technologies of the present disclosure may be applicable not only to photographing or projection of still images but also to photographing or projection of moving images.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) An imaging device including:

an image generator;

a translucent mirror configured to reflect at least a portion of light emitted from the image generator and to emit the reflected light toward an outside of a housing; and

an image sensor configured to receive light transmitted through the translucent mirror among light incident from the outside of the housing.

(2) The imaging device according to (1), further including:

a lens unit configured to include one or more lenses and to be connectable to and detachable from the housing,

wherein, when the lens unit is connected to the housing, the lens unit, the translucent mirror, and the image sensor are arranged substantially in a row.

(3) An imaging device, including:

a connecting portion configured to be connectable to and detachable from an image generation device;

a translucent mirror configured to reflect at least a portion of light emitted from the image generation device and to emit the reflected light toward an outside of a housing; and

an image sensor configured to receive light transmitted through the translucent mirror among light incident from the outside of the housing.

(4) The imaging device according to (3), further including:

a display portion,

wherein, when the image generation device is connected to the connecting portion, an image displayed on the display portion is switched to an image for allowing a user to select whether imaging is to be cancelled.

(5) The imaging device according to (4), wherein the image displayed on the display portion is switched to the image for allowing a user to select whether imaging is to be cancelled when image data related to a subject is acquired and the image generation device is connected to the connecting portion without turning a power supply off.
(6) The imaging device according to any one of (3) to (5), further including:

a controller,

wherein, when the image generation device is connected to the connecting portion, the controller initiates transfer of image data to the image generation device.

(7) An imaging device, including:

a main body configured to include an image sensor; and

a lens unit configured to include one or more lenses and to be connectable to and detachable from the main body,

wherein an image generation device including a translucent mirror is connectable and detachable between the main body and the lens unit, and

wherein, in a state where the image generation device is interposed between the main body and the lens unit, the lens unit, the translucent mirror, and the image sensor are arranged substantially in a row.

(8) A projector unit, including:

a housing configured to include a first connecting portion and a second connecting portion;

a translucent mirror disposed between the first connecting portion and the second connecting portion; and

an image generator,

wherein light reflected by the translucent mirror among light emitted from the image generator is emitted toward an outside through one of the first connecting portion and the second connecting portion.

(8) The projector unit according to (8), wherein the first connecting portion and the second connecting portion have respective connecting mechanisms corresponding to different standards.

The present disclosure contains subject matter related to that disclosed in Japanese Priority Patent Application JP 2012-102237 filed in the Japan Patent Office on Apr. 27, 2012, the entire content of which is hereby incorporated by reference.

What is claimed is:

1. An imaging device comprising:
an image generator;
a translucent mirror configured to reflect at least a portion of light emitted from the image generator and to emit the reflected light toward an outside of a housing; and
an image sensor configured to receive light transmitted through the translucent mirror among light incident from the outside of the housing.

2. The imaging device according to claim 1, further comprising:
a lens unit configured to include one or more lenses and to be connectable to and detachable from the housing,
wherein, when the lens unit is connected to the housing, the lens unit, the translucent mirror, and the image sensor are arranged substantially in a row.

3. An imaging device, comprising:
a connecting portion configured to be connectable to and detachable from an image generation device;
a translucent mirror configured to reflect at least a portion of light emitted from the image generation device and to emit the reflected light toward an outside of a housing; and
an image sensor configured to receive light transmitted through the translucent mirror among light incident from the outside of the housing.

4. The imaging device according to claim 3, further comprising:
a display portion,
wherein, when the image generation device is connected to the connecting portion, an image displayed on the display portion is switched to an image for allowing a user to select whether imaging is to be cancelled.

5. The imaging device according to claim 4, wherein the image displayed on the display portion is switched to the image for allowing a user to select whether imaging is to be cancelled when image data related to a subject is acquired and the image generation device is connected to the connecting portion without turning a power supply off.

6. The imaging device according to claim 3, further comprising:
a controller,
wherein, when the image generation device is connected to the connecting portion, the controller initiates transfer of image data to the image generation device.

7. An imaging device, comprising:
a main body configured to include an image sensor; and
a lens unit configured to include one or more lenses and to be connectable to and detachable from the main body,
wherein an image generation device including a translucent mirror is connectable and detachable between the main body and the lens unit, and
wherein, in a state where the image generation device is interposed between the main body and the lens unit, the lens unit, the translucent mirror, and the image sensor are arranged substantially in a row.

8. A projector unit, comprising:
a housing configured to include a first connecting portion and a second connecting portion;
a translucent mirror disposed between the first connecting portion and the second connecting portion; and
an image generator,
wherein light reflected by the translucent mirror among light emitted from the image generator is emitted toward an outside through one of the first connecting portion and the second connecting portion.

9. The projector unit according to claim 8, wherein the first connecting portion and the second connecting portion have respective connecting mechanisms corresponding to different standards.
